(19) United States
(12) Patent Application Publication
(10) Pub. No.: US 2015/0251561 A1
(43) Pub. Date: Sep. 10, 2015

(54) Air Vehicle and Levitation System for Air Vehicle

(71) Applicant: Airbus DS GmbH, Taufkirchen (DE)

(72) Inventors: Detlev KONIGORSKI, Ehrenburg (DE); Juergen STEINWANDEL, Uhldingen-Muehlhofen (DE); Kan-Ern LIEW, Antwerpen (BE)

(21) Appl. No.: 14/464,265

(22) Filed: Aug. 20, 2014

(30) Foreign Application Priority Data
Aug. 20, 2013 (DE) 10 2013 013 849.3

(51) Int. Cl. B60L 13/04; B64D 37/30; B64D 33/08; B64C 25/00

(52) U.S. Cl. CPC B60L 13/04; B64C 25/001; B64D 37/30; B64D 33/08

(57) ABSTRACT

Magnetically active elements, namely magnets or superconducting elements respectively, are incorporated respectively in an air vehicle and in a guide path on which the air vehicle is to land, take-off and/or taxi. A cooling apparatus may be provided to cool the superconducting elements. The magnets may be electromagnets, and an electrical energy source and a controller are provided to energize the electromagnets in an independently controlled manner. The magnets produce a magnetic field, and the superconducting elements expel the magnetic field and cause a quantum levitation effect, by which the air vehicle is supported in a contact-free manner above the guide path. Thus, the air vehicle may omit mechanical landing gear.

### PRIORITY CLAIM

This application is based on and claims the priority under 35 USC 119 of German Patent Application 10 2013 013 849.3 filed on Aug. 20, 2013. This application is further based on German Patent Application 10 2012 013 053.8 filed on Jul. 2, 2012. The entire disclosures of both of these German Patent Applications are incorporated herein by reference.

### FIELD OF THE INVENTION

The invention relates to an air vehicle equipped so as to be supported above a ground surface such as a runway, taxiway or the like, as well as a system comprising such an air vehicle as well as a guide path on the ground surface by which the air vehicle can be supported and guided. The invention further relates to a method for supporting and spacing the air vehicle from the guide path.

### BACKGROUND INFORMATION

It is conventionally known to equip an air vehicle with a landing gear including wheels on which the air vehicle is supported when it lands on, rolls along, and takes off from a ground surface including a guide path such as a take-off and landing runway, a taxiway, a taxiing and maneuvering area, an apron area, or other tarmac areas of an airport, airfield or the like. The landing gear establishes a physical contact between the guide path and the air vehicle and physical structural support of the air vehicle. In other known embodiments, the landing gear can involve fixed skids, skis, flotation pontoons or the like, for landing on various different ground surfaces including snow, turf, sand, water, etc. In each case, such landing gear establishes physical contact between the air vehicle and the guide path on the ground surface. As a result, relatively high mechanical loads are applied through the landing gear to the body of the air vehicle. Additionally, any bumps or unevenness in the guide path on the ground surface are also transmitted through the landing gear into the air vehicle, and thus into any passenger cabin of the air vehicle. As a result, the landing, take-off and rolling stages of a flight of a passenger aircraft can sometimes be uncomfortable for the passengers. Furthermore, due to the required high strength of the landing gear structure, it also has a relatively high weight and takes up a significant volume when retracted into the air vehicle. This of course has negative influences on the overall energy balance, and the available payload weight and payload volume of the air vehicle. Still further, because the conventional landing gear is arranged on and connected to the air vehicle body at relatively small areas, the landing gear exerts strongly localized forces into the air vehicle body only at these relatively small areas. As a result, the air vehicle body must be sufficiently strong to withstand and disperse or further transmit the resulting high localized introduction of forces. That also causes an increased weight of the air vehicle to achieve the required strength and rigidity. Still further, the landing gear protruding downwardly from the belly of the aircraft creates significant aerodynamic drag, and rolling along the runway creates mechanical friction, which consequently impede the take-off acceleration of the aircraft, which thus requires a longer take-off runway. In order to make the landing gear retractable during flight to avoid the aerodynamic penalty, additional mechanical, electrical and hydraulic retraction systems and components are necessary, which further add to the weight and complexity.

It has also become known from the German Patent Publication DE 41 02 271 C2, to omit a permanent landing gear from an aircraft, and instead to provide a sled or carriage that remains on a guide track on the ground, for example on a take-off and landing runway of an airport. The aircraft is supported on the ground-based carriage during taxiing and take-off, and for landing the aircraft must again land precisely onto the carriage as the carriage moves along the guide track on the ground. The carriage may be levitated and guided along the guide track by magnetic levitation achieved by magnetic repulsion of suitably controlled electromagnets. However, that known system has the significant disadvantage that a highly precise control of the ground-based carriage is necessary using a highly technical control arrangement, in order to match the motion of the carriage to the motion of the approaching aircraft during the landing phase, to ensure that the aircraft is properly captured and seated onto the carriage when the aircraft lands. This also requires highly precise guidance of the aircraft during its landing procedure. Even relatively small deviations from the optimal positioning of the aircraft onto the carriage can lead to problems, or even a total no-gear landing or crash of the aircraft if it is not properly captured onto and supported by the ground-based carriage.

It has separately become known to use magnetic levitation for supporting and guiding vehicles in a different field of application, namely ground-based vehicles and particularly maglev trains that remain permanently supported on and travel along a magnetic guide rail. Such maglev trains have been used especially in Japan and in the Transrapid system developed in Germany. Using such maglev technology, the trains can be suspended or supported, guided and propelled without the use of wheels or other mechanically contacting devices. Known maglev trains use various different types of levitation and drive or propulsion technologies, which can generally be divided into two types: namely electromagnetic suspension (EMS) and electrodynamic suspension (EDS). The Japanese maglev trains generally use EDS while the Transrapid system trains generally use EMS.

The EMS technology achieves levitation through the use of electromagnets to cause magnetic repulsion between a magnetic element in the train and a magnetic element in the track. The EMS system has the advantage that the magnetic repulsion and thus levitation can be used at all speeds and even at a standstill, but the train must include guide elements that are clamped or bracketed around the support rail. Furthermore, this system has the disadvantage that it must be continuously monitored and precisely regulated through the use of computer systems in order to maintain the stability of the magnetic levitation.

On the other hand, the EDS technology provides a more stable magnetic levitation and does not require a constant regulation and correction because the repulsive magnetic forces are produced by induced magnetic fields that arise due to the motion of the train along the track. However, as a result, there is the disadvantage that the levitation can only be maintained when the train is traveling at a sufficiently high speed, because the arising induced magnetic flux is insufficient for levitation at low travel speeds of the train. Therefore, the EDS system requires additional wheels or other mechanical support devices to support the train during low speed travel and at a standstill.

Because of the abovementioned disadvantages and limitations of the known maglev train systems, such system using magnetic levitation would not be suitable and have not been incorporated into air vehicles for the direct levitation of the air vehicle over a guide path on the ground surface. For example, in the EMS system, because the train or other vehicle must engage around the support and guide track, to maintain the levitation and guidance, therefore such a system is not suitable for supporting a landing air vehicle because the required precise alignment of the air vehicle with the track could not be achieved reliably under all weather conditions and the like. On the other hand, the EDS system would require a landing gear with wheels for support and operation of the aircraft at low taxiing speeds on the ground. While magnetic levitation has been suggested for an aircraft support carriage in the German Patent Publication DE 41 02 271 C2 as discussed above, that system also would suffer significant problems in actual use as discussed above, and did not suggest use of magnetic levitation technology or equipment directly in the aircraft for interaction with magnetically active devices in the guide path on the ground surface.

It has further been contemplated to equip vehicles with superconductors for various purposes, for example in the form of an electrodynamic heat shield (EDH), or for energy storage or current or flow control, or in higher efficiency generators and motors. It has not, however, been previously contemplated to utilize superconductors in an air vehicle for suspension purposes, such as the take-off, landing and taxiing of air vehicles as pertinent in the present application.

It is known that certain materials, so-called high temperature superconductors, become superconducting at relatively high temperatures, namely that the superconducting critical or transition temperature is at or above the boiling point of liquid nitrogen. Such high temperature superconductors, for example, include copper oxide superconductors. Other superconductors are also already known that have a critical or transition temperature for superconducting in the range of the freezing point of water or even at typical room temperature, for example as described in the German Patent Publication DE 10 2008 047 334 B4.

The interaction of magnets (e.g. either permanent magnets or electromagnets) relative to one another in order to achieve magnetic levitation as well as magnetic drive or propulsion is based on the principle of magnetic attraction of opposite magnetic poles and magnetic repulsion of two same magnetic poles. On the other hand, the so-called “quantum levitation” effect that can be achieved by the interaction of superconductors and magnetic fields is based on a principle of ejection or expulsion of a magnetic field out of the interior of the superconducting material, generally known as the Meissner-Ochsenfeld effect, which is illustrated in FIGS. 9A and 9B. FIG. 9A shows the situation at a temperature above the critical transition temperature of a superconducting material represented by the circular depiction of a sphere or cross-section of a superconductor. In this situation, the magnetic field represented by the arrows penetrates and permeates through the interior of the material. On the other hand, when the temperature falls below the critical transition temperature of the superconducting material as shown in FIG. 9B, the magnetic field is spontaneously excluded or expelled or displaced out of the material which now exhibits superconducting behavior. Actually, the external magnetic field penetrates into the superconducting material up to approximately 100 nanometers at the outer surface thereof, and counteracting currents are induced in this outer surface, which gives rise to an induced magnetic field that cancels and thus expels or excludes the external magnetic field from the deeper interior of the superconducting material. The interior of the superconducting material thus remains free of magnetic field. As a result of this expulsion of an external magnetic field, this gives rise to a repulsion or locking between the superconductor and the source of the external magnetic field, for example a permanent magnet or an electromagnetic coil. This establishes a levitation condition in which there is no physical contact between the superconductor and the magnetic field source. This so-called expulsion or ejection of the magnetic field is independent of whether the material was already in a superconducting state before the application of the external magnetic field, or whether the magnetic field was applied first and then thereafter the material became superconducting. Furthermore, this Meissner-Ochsenfeld effect is not dependent on the previous history of the material and is thus fully reversible, repeatable and can be switched on and off, for example by adjusting the temperature of the material to either below or above its superconducting critical or transition temperature. It is known to use this Meissner-Ochsenfeld effect in levitation demonstrations and in superconducting magnetic bearings.

### SUMMARY OF THE INVENTION

In view of the above, it is an object of at least one embodiment of the invention, to provide an improved air vehicle that avoids, overcomes or reduces the disadvantages mentioned above, and especially an air vehicle that does not need a mechanical landing gear to make mechanical supporting ground contact with a guide path on a ground surface on which the air vehicle lands, takes off or taxies. It is a further object of an embodiment of the invention to provide a levitation system for an air vehicle, which can support, guide and/or propel an air vehicle spaced above a guide path on a ground surface when the air vehicle lands, takes off or taxies, without physical contact between the air vehicle and the ground surface. One or more embodiments of the invention further aim to avoid or overcome the disadvantages of the prior art, and to achieve additional advantages, as apparent from the present specification. The attainment of these objects, is however, not a required limitation of the claimed embodiments of the invention.

One or more of the above objects can be achieved according to the invention in that a first magnetically active element is incorporated in an air vehicle and a second magnetically active element is incorporated in a guide path on a ground surface on which the air vehicle lands, takes off or taxies. Each magnetically active element may be a magnet that produces a magnetic field or a superconducting element that expels or ejects or otherwise interacts with the magnetic field. The magnet or magnetic element may comprise one or more permanent magnets, one or more electromagnets, and/or a combination of one or more permanent magnets and one or more electromagnets. The air vehicle may be any vehicle or device that is designed and constructed to move through the air, including fixed wing aircraft for the transportation of passengers, cargo or equipment, rotary wing aircraft such as helicopters, lighter than air aircraft, rocket powered vehicles such as rockets, missiles and the like, spacecraft including single-use and reusable is spacecraft, including space rockets, booster vehicles, space shuttles and other spacecraft designed for reentry and landing on earth. One class or category of such air vehicles has wings (fixed or rotary) for generating lift, by which the vehicle flies in the air, and can take off from and land on a guide path on the ground surface. Such winged air vehicles also typically taxi along a guide path on the ground surface. Another class or category of such air vehicles does not have lifting wings, e.g. such as a rocket or missile that is launched vertically or at an angle from a launch platform or other launcher. Such vehicles do not take off from a runway, but can be taxied along a guide path on the ground surface in order to reach the launch location. The air vehicles may be manned or unmanned.

In one embodiment, at least one superconducting element is incorporated in the air vehicle and at least one magnetic element is incorporated in the guide path on a ground surface on which the air vehicle lands, takes off and/or taxies. In another embodiment, at least one magnetic element is incorporated in the air vehicle while at least one superconducting element is incorporated in the guide path on the ground surface on which the air vehicle lands, takes off, and/or taxies. In both such embodiments, the interaction of the superconducting element with the external magnetic field produced by the magnetic element produces a quantum levitation effect by which the air vehicle can be spaced apart and supported above and guided along the guide path on the ground surface. Thus, the invention makes use of the generally known physical effect discussed above, namely that the external magnetic field is excluded or expelled from the superconducting element so as to produce a repulsion or a spacing distance locking between the magnet that produces the magnetic field and the superconducting element. According to an embodiment of the invention, this effect supports and guides the air vehicle above the guide path on the ground surface as the air vehicle taxies, takes off and/or lands, while avoiding a physical contact between the air vehicle and the ground surface. Thus, according to an embodiment of the invention, a contactless landing of the air vehicle is possible as long as the magnetic field is strong enough to establish and maintain a sufficiently large spacing distance between the air vehicle and the guide path on the ground surface, and the superconducting element is appropriately dimensioned, selected and configured so that it can maintain its superconducting properties in the presence of such a strong magnetic field and weight loading, and also still exclude the magnetic field so as to maintain the levitation effect.

The interaction of the magnetic element and the superconducting element allows the spacing distance between the air vehicle and the guide path on the ground surface to be constantly maintained, because it does not alter the external magnetic field, unlike the situation when two opposed magnets approach one another.

In one or more embodiments of the invention, the magnetic elements comprise electromagnets, and the system further comprises an electrical energy source and a controller to control the application of electrical energy to the electromagnets so as to adjust and control the strength, configuration and time varying development of the magnetic field. Also in one or more embodiments of the invention, if the superconducting elements have a superconducting critical transition temperature below ordinary operating or room temperature, then the system further comprises a cooling apparatus to cool the superconducting elements below the critical temperature thereof. If the superconducting elements are incorporated in the air vehicle, then the cooling apparatus is also incorporated in the air vehicle. If the superconducting elements are incorporated in the guide path on the ground surface, then the cooling apparatus is also provided on the ground. If the electromagnets are provided in the air vehicle, then the electrical energy source and the controller are also provided in the air vehicle. If the electromagnets are provided on the guide path on the ground surface, then the electrical energy source and the controller are also provided on the ground. Thus, depending on the particular situation, it may be more advantageous to arrange the superconducting elements in the air vehicle and the magnetic elements on the ground, or vice versa. For example, if cryogenic cooling apparatus is already present in the air vehicle, for example if the air vehicle includes other systems with superconducting components, or if the air vehicle already includes cryogenically cooled liquids such as fuel for fuel cells, then the superconducting elements of the levitation system can be incorporated in the air vehicle without a significant weight penalty. On the other hand, if the air vehicle already includes an electrical energy source with the required capacity, then the electromagnetic elements of the levitation system can be incorporated in the air vehicle without weight penalty of an additional energy source.

Several embodiments of the invention achieve various advantages. For example, the high mechanical loads that arise during landing are reduced, cushioned and thus compensated or evened out, and can be distributed over a larger area, in comparison to the localized point loading that arises with conventional mechanical landing gear. This leads to reduced demands on the structural integrity of the body of the air vehicle, so that the material thickness and strength of the various components can be reduced, and thereby also the overall mass of the air vehicle is reduced. This in turn leads to a reduction of the required fuel quantity for a given flight range of the air vehicle, and/or an increase of the usable payload weight and/or volume. A further advantage is that the heavier and/or more energy intensive components can be selectively arranged on the ground while the lighter and/or less energy intensive components are arranged in the air vehicle. Furthermore, the landing levitation system as well as a landing method achieved using this landing system is also functional in outer space conditions, so that it also can be applied for landing air vehicles on non-earth ground surfaces such as ground surfaces of other planets or moons, or on man-made landing surfaces in space. A further advantage of one or more embodiments of the invention is that it does not require an electronic regulation or control in the simplest case, in contrast to the Transrapid magnetically levitated train, and does not require a minimum effective travel speed of the vehicle as is the case with the Japanese magnetically levitated train.

Furthermore, according to one or more embodiments of the invention, in connection with landing the air vehicle on the guide path on the ground surface, it is not necessary to achieve a precise alignment of the air vehicle with the guide path. Furthermore it is not necessary to provide a precisely controlled support carriage or sled onto which the air vehicle must precisely land, as known in the prior art discussed above. In fact, in a preferred embodiment of the invention there is no interposed device between the air vehicle and the guide path, but instead only a spacing distance or gap therebetween established by the interaction of the superconducting elements with the magnetic field produced by the magnetic elements. Generally it can be sufficient to produce a constant magnetic field on or in the guide path. This constant magnetic field is not influenced by the approach of the superconducting element, so that it becomes possible to establish a constant spacing distance of the air vehicle from the guide path. Thus, with an embodiment of the invention, the air vehicle includes absolutely no physical or mechanical landing gear that makes physical contact with, and allows the air vehicle to roll or slide along, a guide path on the ground surface. Alternatively, the air vehicle may additionally include a mechanical support structure on which the air vehicle rests when it is parked and thus does not need to be levitated. As a further alternative, the air vehicle may additionally include a landing gear with wheels, skids, skis, pontoons or the like for emergency use if the levitation system has failed, or for landing, take-off and/or taxiing at an airport, airfield or other area not equipped with the ground-based counterpart components of the levitation system.

To be propelled and move along the ground surface while taxiing or for take-off, for example, the air vehicle can be propelled by its own propulsion thrust drives such as jet engines, turbofan engines, motor-driven propellers or fans, or the like. Ground based vehicles such as a transport tug or the like may also engage and propel the air vehicle for taxiing, for example. Preferably, however, even during such ground taxiing and the like, the air vehicle is levitated by the levitation system, via the required magnetically active elements incorporated in the guide path along not only the take-off and landing runway, but also the taxiways, taxiing and maneuvering areas, apron areas, parking areas, and/or other tarmac areas or even grass-covered areas of the airport.

In an especially preferred embodiment, the magnetic field generation device comprising the magnetic elements is embedded in the guide path on the ground surface. The ground surface can be a smooth planar surface, without needing grooves or rails therein or thereon for guidance purposes. In this manner, the surface material and appearance of the guide path can be visually and aesthetically adapted to the surrounding landscape, which is not possible in the case of conventional concrete or asphalt runways and the like. Namely, the surface of the guide path does not need to be covered with a hard concrete or asphalt surface, because there is no physical contact with landing wheels of an aircraft landing gear or the like. Instead, the surface of the guide path can be covered with grass or other vegetation, or gravel, or even water in a shallow pond or basin.

In another preferred embodiment, the guide path is portable and may be temporarily arranged at any available suitable ground surface area. For example, an emergency landing strip can be quickly and easily prepared simply by laying out the portable guide path onto a suitable field or even onto a suitable roadway that has the necessary length. Alternatively, in another preferred embodiment, the guide path is a fixed stationary guide path that is permanently installed on, in or under a runway, taxiway, apron area, or the like of an airport.

Preferably, the superconducting elements of the levitation system comprise a high temperature superconducting material, and especially a material that exhibits superconducting properties at temperatures greater than the boiling point of nitrogen, for example at temperatures from −200° C. to ordinary room temperature. Such materials are already well known and develop their superconducting properties at temperatures that are easily achievable in an air vehicle. For example, if superconducting materials are used that have a superconducting transition temperature slightly above the boiling point of nitrogen, these superconducting elements can easily and advantageously be cooled with liquified air that is readily available and easily storable in an air vehicle. According to a further preferred feature of the invention, the superconducting material of the superconducting elements is cooled down below its transition temperature only shortly before the required use of the levitation system, for example before the landing, while at other times the superconducting material is not cooled but instead is allowed to come to the prevailing ambient temperature. This reduces the cooling load and thus the associated energy load. The cooling simply needs to begin sufficiently before the use of the levitation system so that the required superconducting temperature is achieved and the magnetic field expulsion effect is generated in time before the levitation effect is needed, e.g. for the landing.

For example in particular embodiments, the superconducting material of the superconducting elements can be yttrium barium copper oxide (YBCO) and/or bismuth strontium calcium copper oxide (BSCCO) and/or mercury barium calcium copper oxide and/or mercury silver thallium barium calcium copper oxide. These materials develop their superconducting properties at temperatures around the boiling temperature of nitrogen, that is to say at approximately −200° C. These temperatures can advantageously be achieved through the use of readily available liquid air, so that these materials are especially preferred for use in the superconducting elements incorporated in the air vehicle. As a further alternative, materials that develop superconducting properties at room temperature can be utilized, for example as described above, so that no special cooling apparatus is required.

In some embodiments, however, a cooling apparatus is provided for cooling the superconducting elements. The cooling apparatus cools the superconducting material to a temperature preferably below its superconducting critical or transition temperature, so that these elements become superconducting and interact with the external magnetic field of the magnetic elements in the guide path as discussed above. In an example embodiment, the cooling apparatus comprises a nitrogen based cooling unit that cools the superconducting elements with liquid nitrogen. Alternatively or additionally, the cooling apparatus comprises a hydrogen based cooling unit for cooling the superconducting elements with cryo-compressed hydrogen and/or liquified hydrogen. Both liquid nitrogen as well as cryo-compressed or liquid hydrogen are readily available and can easily be stored and/or produced in the air vehicle. In a further preferred embodiment, the cooling apparatus is additionally configured and arranged for cooling other devices, components, units or systems that are present in the air vehicle and that need to be cooled, for example components of a superconducting electric propulsion system. In a further preferred embodiment, the cooling apparatus can alternatively or additionally be used to supply fuel to fuel cells of the air vehicle, for example after using liquified hydrogen for cooling the superconducting elements, the hydrogen is then supplied as a fuel to the fuel cells. The fuel cells may produce electrical energy for use onboard the aircraft and/or may be components of the air vehicle propulsion or drive system. For example, the electrical energy produced by the fuel cells can drive one or more electric motors, e.g. superconducting motors, that each drive a propulsion propeller or fan.

In the above described embodiments, the structural installation space and also the weight can be reduced or saved, and several functions can be fulfilled simultaneously, for example simultaneously providing cooling for the superconducting elements and cooling for superconducting components of a drive or propulsion system, or cooling the superconducting elements and also providing fuel to a fuel cell.

Preferably, the superconducting elements of the levitation system are incorporated in one or more areas of the air vehicle that are oriented generally toward (e.g. on the lower half of the air vehicle fuselage) the guide path as the air vehicle approaches the guide path for a landing. For example, the superconducting elements are arranged in the fuselage belly area of the air vehicle. Thus, as the air vehicle approaches the guide path on the ground surface, thereby the superconducting elements will be positioned generally close to, or as close as possible to, the magnetic elements in the guide path on the ground surface. This minimizes the spacing distance between the superconducting elements and the magnetic elements for achieving the required physical spacing distance between the air vehicle and the guide path on the ground surface. This in turn advantageously leads to the lowest possible energy consumption for generating the required magnetic field using electromagnets as the magnetic elements. Preferably, the electromagnets are only energized when needed for landing, take-off and/or taxiing of the air vehicle, i.e. the electromagnets do not need to be energized when there is no air vehicle needing to be levitated.

In a further preferred embodiment, the air vehicle has a propulsion drive system that is based on or incorporates superconductors, e.g. including superconducting electric motors and/or superconducting electric generators. Advantageously, structures and equipment of the cooling apparatus can be used for cooling both the superconductors of the propulsion drive system as well as the superconducting elements of the levitation system. In a further alternative embodiment, the air vehicle has a combination of plural propulsion drive systems, for example a combination of a drive based on or incorporating superconductors and a drive based on or incorporating fuel cells, or a combination with a conventional drive based on an engine fueled with kerosene or jet fuel.

The at least one magnetic element makes up a magnetic field generating arrangement that comprises at least one magnet, which may comprise one or more permanent magnets and/or one or more electromagnets. The provision of plural magnets is preferred, and especially electromagnets are preferred. Electromagnets have the advantage that the strength of the produced magnetic field can be adjusted and in fact individually controlled, so that the strength and configuration of the magnetic field can be adjusted or varied as a function of location along the guide path and as a function of time. Thus, for example, the magnetic field can be adapted to the weight of the air vehicle that will be landing. Also, the length and/or area of the active magnetic field can be adjusted depending on the type, length, width, and weight of the air vehicle.

In this regard, a further preferred embodiment of the invention provides an electrical energy source to supply electrical energy to the at least one electromagnet, and preferably further a controller for selectively activating, deactivating and/or adjusting the magnitude or strength of the field of each respective electromagnet. It is preferably possible to actuate or power the electromagnets individually under individual control. Thereby it is possible to support and guide the air vehicle over and along the guide path with a minimum energy consumption.

Another embodiment of the invention relates to a method for supporting and spacing an air vehicle above a guide path, for example for landing, taxiing or take-off launching the air vehicle. At least one superconducting element is provided on or in the air vehicle while at least one magnetic field generating arrangement is provided in or on the guide path, or alternatively at least one superconducting element is provided in or on the guide path and at least one magnetic field generating arrangement is provided in or on the air vehicle. The method involves flying the air vehicle to approach the guide path, cooling the superconducting element below its superconducting transition temperature, activating the magnetic field generating arrangement to produce a magnetic field, and then levitating the air vehicle above the guide path due to the interaction of the superconducting element with the magnetic field.

### BRIEF DESCRIPTION OF THE DRAWINGS

In order that the invention may be clearly understood, it will now be described in further detail in connection with example embodiments thereof, with reference to the accompanying drawings, wherein:

FIG. 1 is a schematic side view representation of an example embodiment according to the invention, with at least one superconducting element arranged in an air vehicle and magnetic elements arranged in a guide path on the ground surface;

FIG. 2 is a schematic side view representation of an alternative embodiment according to the invention, with magnetic elements arranged in the air vehicle and a superconducting element arranged in the guide path on the ground surface;

FIG. 3 is a schematic top view illustration of the example embodiment of FIG. 1;

FIG. 4 is a schematic perspective view of an air vehicle taking off from a runway equipped as a guide path according to an embodiment of the invention;

FIG. 5 is a schematic perspective view of further details of the arrangement of FIG. 4, showing superconducting elements in the air vehicle and magnetic elements in the guide path;

FIG. 6 is a schematic illustration of the air vehicle of FIGS. 4 and 5, but here showing additional system components including a cooling apparatus;

FIG. 7 is a schematic sectional side view of plural electromagnets as magnetic elements embedded in a guide path on the ground surface according to FIG. 4;

FIG. 8 is a schematic top view illustration of a portable guide path including plural electromagnets connected to one another by electrical cables; and

FIGS. 9A and 9B illustrate the Meissner-Ochsenfeld effect at temperatures above and below the superconducting transition temperature.

### DETAILED DESCRIPTION OF EXAMPLE EMBODIMENTS AND THE BEST MODE OF THE INVENTION

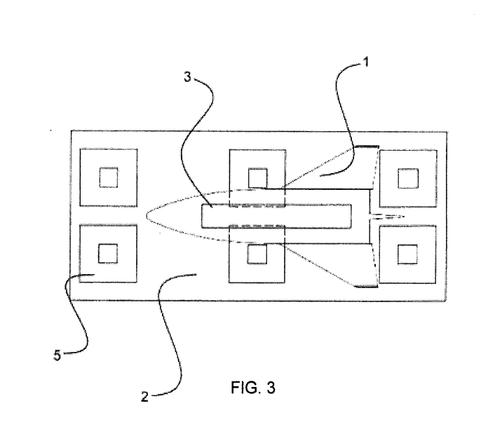

FIGS. 1 and 3 schematically illustrate a side view and a top view, respectively, of a first example embodiment of the invention involving an air vehicle 1 that is flying a landing approach above a landing and take-off runway 2. The air vehicle in this embodiment is a fixed wing aircraft that has aerodynamic lift-generating wings as well as aerodynamic control surfaces such as elevators, ailerons and a rudder (not individually shown) for aerodynamically controlling the flight of the air vehicle 1 in pitch, roll and yaw in the air, separate and independent from the runway 2. The air vehicle 1 also has thrust engines or a thrust drive system for propelling the air vehicle 1 through the air. The runway 2 is embodied or equipped as a guide path on a ground surface according to the invention.

In this embodiment, at least one superconducting element 4 is arranged in a cryostat 3 in an area along the bottom or belly of the air vehicle 1. Additionally, at least one superconducting element 4 can be arranged in a cryostat 3 along bottom surfaces of the wings of the air vehicle 1 (not shown). The cryostat 3 may constantly maintain the temperature of the superconducting element 4 at or below the critical superconducting transition temperature. Alternatively, the cooling is provided by an active controllable cooling system, for example through the use of liquified gases, for example in the case of flight in earth's atmosphere or near-earth space travel, by cooling with cryo-coolers, also applicable in the case of near-earth space travel or air flight within earth's atmosphere, or through the use of a special cooling technology solely through the prevailing surrounding ambient or environmental conditions, for example using the extreme cold of deep space or even the cold at high altitudes or near-earth space conditions. Such cooling is suitable if appropriate superconductors with a sufficiently high transition temperature are available. The cryostat 3 may be integrated as an independent subsystem into the air vehicle 1, or it can represent a system-integrated component of one or more other systems of the air vehicle 1. Alternatively, if the superconducting material has a superconducting transition temperature at room temperature or a normal ambient operating temperature inside the air vehicle, then the cryostat 3 can be omitted. The air vehicle 1 or at least the underside area thereof, and the cryostat 3 are preferably made of fiber reinforced composite materials and/or other suitable materials (such as nickel or another similar metal) that will not hinder or not prevent the desired interaction between the superconducting element 4 and an externally applied magnetic field 6.

The runway 2 is embodied or equipped as a guide path on the ground surface according to the invention in that plural magnetic elements 5, and particularly permanent magnets, or electromagnets, or a combination of permanent magnets and electromagnets are arranged under the surface of the runway 2. An electrical energy source 7 is connected to the one or more electromagnets to energize the same. A controller may also be provided to control the actuation of each electromagnet. The electromagnets may be superconducting electromagnets. The magnetic elements 5 each produce an external magnetic field 6. In the case of superconducting magnets, the magnets must be suitably cooled. Such superconducting magnets will be in continuous current operation, as is the case for the magnets of magnetic resonance tomography (also called nuclear magnetic resonance or magnetic resonance imaging) equipment, so that there is no electrical power consumption or loss other than that necessary for the cooling.

As discussed above, the superconducting element 4 in the air vehicle 1 excludes or expels the magnetic field 6 produced by the magnetic elements 5 (for example as shown in FIG. 9B), which in turn produces a contact-free levitating or supporting force by which the air vehicle 1 is supported above the runway 2.

Through the use of adjustable electromagnets as some or all of the magnetic elements 5, the field strength of the magnetic field 6 and thus the levitation force can be adjusted to the weight of the air vehicle 1. In general, the magnetic field 6 is produced with sufficient field strength so that it establishes and maintains a sufficiently large spacing distance between the air vehicle 1 and the runway 2, so as to prevent a physical contact between the air vehicle 1 and the runway 2, and thus to achieve a contact-free landing of the air vehicle 1. Furthermore, the individual magnetic fields 6 may be activated and deactivated sequentially along the runway 2 during the landing process, so that only the minimum number of magnetic elements 5 (e.g. those magnetic elements located under the air vehicle) need to be energized at any time. Also, the individual control and energization or de-energization of individual ones of the electromagnets 5 allows the air vehicle 1 not only to be levitationally supported above the runway 2, but also guided and moved along the guide path formed by the magnetic elements 5 along the runway 2.

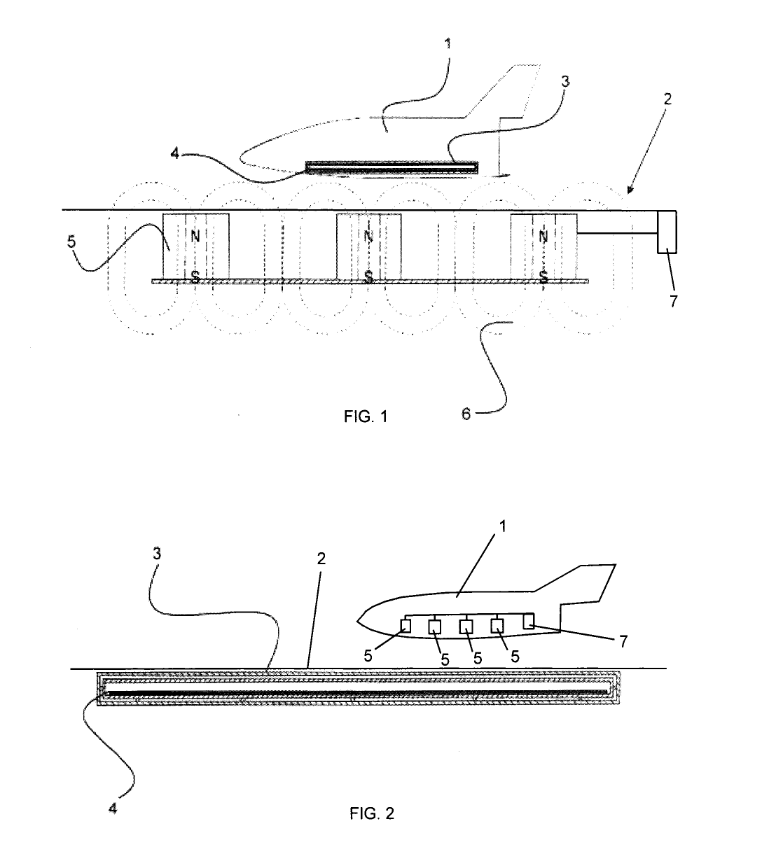

FIG. 2 shows an alternative example embodiment in which the superconducting element 4 and the magnetic elements 5 have essentially been reversed in comparison to the embodiment of FIG. 1. Namely, in FIG. 2, magnetic elements 5 such as electromagnets 5 and the associated electrical energy source 7 are arranged in the air vehicle 1, while at least one superconducting element 4 is arranged in a cryostat 3 under the surface of the runway 2. The electromagnets 5 in the air vehicle 1 are energized to produce a magnetic field, which is excluded or expelled by the superconducting element 4 under the runway 2, so as to produce a levitation force as described above. In a further alternative, plural individual superconducting elements are arranged along the runway 2, and are individually controlled to effectively switch on or off the superconducting behavior thereof (e.g. by changing the temperature), in order to control or adjust the levitation effect along the runway.

In both of the embodiments of FIGS. 1 and 3 and FIG. 2, the magnetically effective elements 2 or 5 cover a lower belly surface portion of the fuselage body of the air vehicle, which may have an area amounting to at least 25% of a plan form area of the fuselage body or has an axial length amounting to at least 50% of an axial length of the fuselage body. Alternatively, the magnetically effective elements 2 or 5 cover lower wing surface portions of the wings of the air vehicle, which may each have an area amounting to at least 25% of a plan form area of each of the wings or each have a length amounting to at least 50% of a length of each of the wings. This may provide sufficient area to achieve the necessary levitation effect, and distributes the loads over a larger area and a larger structure of the airframe of the air vehicle in comparison to the localized point loading applied by conventional mechanical landing gear.

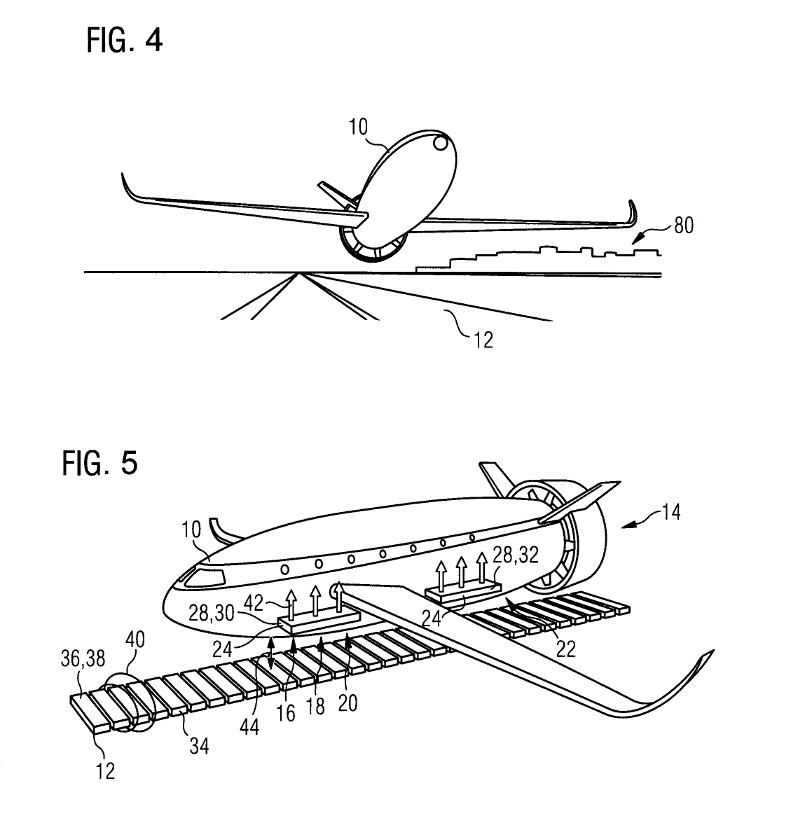

FIG. 4 shows a perspective view of a different embodiment of an air vehicle 10 taking off from a guide path 12 embodied as a runway of an airport 80.

FIG. 5 schematically shows further details of a system 14 including the air vehicle 10 and the guide path 12 of FIG. 4. FIG. 5 schematically shows components of the system incorporated in the interior of the air vehicle 10 as well as in the guide path 12. At least one superconducting area 18 is provided on or in a belly area 16 of the fuselage body of the air vehicle 10, whereby this fuselage belly area 16 is generally oriented toward the guide path 12. The at least one superconducting area 18 includes a forward partial area 20 and a rear or aft partial area 22 in the illustrated example embodiment. Additionally, or alternatively, one or more superconducting areas (not shown) can be provided on the bottom surface of each wing of the air vehicle 10. Such additional or alternative superconducting areas on the wings distribute the landing and levitation loads over a larger area of the air vehicle 10, and also apply loads in the same positive loading direction as the wing loads during normal flight, thereby allowing the structure of the air vehicle to be less strong and lighter. Providing superconductor areas on the wings also helps to stabilize the levitation support of the air vehicle 10 against rolling motions while the air vehicle 10 is taxiing, taking-off or landing. In any event, the superconducting areas are provided over a sufficient total surface area to achieve the required levitation support for the weight of the air vehicle 10. Each superconducting area 18 comprises one or more superconducting elements comprising superconducting materials, preferably high temperature superconducting materials 24.

In the present example embodiment, the high temperature superconducting materials 24 are preferably formed of ceramics 26 based on cuprates 28, for example preferably yttrium barium copper oxide (YBCO) 30, and/or bismuth strontium calcium copper oxide (BSCCO) 32. These materials YBCO 30 and BSCCO 32 have superconducting transition temperatures in the region or range of the boiling point of nitrogen, that is to say they develop their superconducting properties at temperatures below this critical transition temperature.

In order to produce the required magnetic field 40 for interacting with the superconductor areas 18, the guide path 12 comprises a plurality of magnets 36 forming a magnetic field generation arrangement 34. The individual magnets 36 are arranged one after another and connected to one another, for example by electrical energy supply cables and optionally control cables, and/or mechanical connections, in order to form the guide path 12 incorporated on, in or under the runway surface as a ground surface. In this example embodiment, the magnets 36 are preferably formed by electromagnets 38.

As the air vehicle 10 approaches the guide path 12 for landing thereon, the electromagnets 38 are activated by supplying electrical energy thereto, so that they generate a constant magnetic field 40. As indicated by the arrows 42, this magnetic field 40 is expelled or excluded from the superconducting partial areas 20 and 22 of the air vehicle 10, so as to produce a repulsion or “quantum levitation” effect, or optionally a “quantum locking” effect, such that a constant spacing distance 44 is established between the air vehicle 10 and the guide path 12. As long as the superconducting areas 18 remain superconducting and the magnetic field 40 is also maintained, this spacing distance 44 will also be maintained, i.e. the air vehicle 10 cannot come any closer to the guide path 12.

Thus, to arrangement or system 14 comprising the air vehicle 10 as well as the guide path 12 outfitted or equipped with respective magnetically active elements, i.e. magnets on the one hand and superconducting elements on the other hand, thus avoids the need for a physical mechanical landing gear on the air vehicle 10, because the air vehicle 10 is instead supported by so-called “quantum levitation” or so-called “quantum locking” due to the interaction of the superconducting elements with the magnetic field produced by the magnets. This levitation effect supports the air vehicle 10 above the guide path 12 wherever the guide path is provided, for example for take-off and landing of the air vehicle 10 on a runway, or for taxiing of the air vehicle on a taxiway, maneuvering area, apron area or other areas of an airport, airfield or any other suitable ground surface area. The magnetically active guide path can also be provided along the surface of an aircraft carrier ship, for example, to facilitate the landing, take-off and maneuvering of the air vehicle on the deck of the aircraft carrier ship.

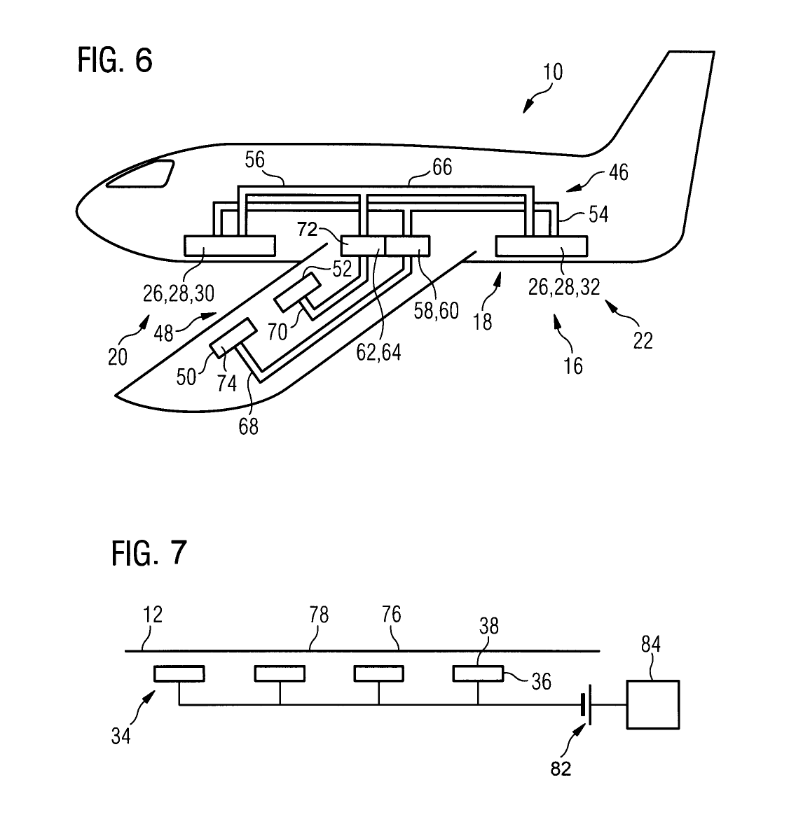

FIG. 6 shows further details of the arrangement of the superconducting partial areas 20 and 22 in the air vehicle 10, in a simplified schematic manner. In this arrangement, the system further includes a cooling apparatus 46. The air vehicle 10 further comprises a drive 48 formed of a combination of a superconducting drive 50 and a fuel cell 52. Both the superconducting partial areas 20 and 22 of the levitation system as well as the superconducting drive components 50 and 52 are cooled by, e.g. supplied cooling fluid from, the cooling apparatus 46. In this embodiment, the cooling apparatus 46 comprises a nitrogen based cooling unit 54 as well as a hydrogen based cooling unit 56.

In that regard, the nitrogen based cooling unit 54 cooperates with a first reservoir 58 for storing liquid nitrogen 60, and the hydrogen based cooling unit 56 cooperates with a second reservoir for storing liquified hydrogen 64. First lines 66 lead respectively from both the nitrogen based cooling unit 54 as well as the hydrogen based cooling unit 46 to the superconducting partial areas 20 and 22, in order to supply liquid nitrogen 60 or liquified hydrogen 64 respectively to the partial areas 20 and 22. These supply “lines” may comprise pipes, hoses, ducts, channels, conduits, or any other device forming a flow passage for flowing the fluid therethrough.

Furthermore, a second line 68 leads from the first reservoir 58 to the superconductor drive 50 in order to cool it similarly with liquid nitrogen 60. A third line 70 leads from the second reservoir 62 to the fuel cell 52, in order to supply liquified hydrogen 64 as a combustible fuel 72 to the fuel cell 52.

Thus, the cooling apparatus 46 is embodied for cooling not only the superconducting areas 18 of the levitation system, but also the further air vehicle devices or units 74 such as the superconducting drive 50, for example, and can also simultaneously supply fuel 72 to the fuel cell 52.

FIG. 7 further shows additional details of the guide path 12 in a simplified schematic manner. In this embodiment, the guide path 12 is established on or along a taxiway, taxiing and maneuvering area, apron area or other tarmac area 76, and/or on or along a take-off and landing runway 78 of an airport 80, for example as shown in FIG. 1. To form the guide path 12, a plurality of electromagnets 38 are embedded in the taxiway 76 and/or runway 78. Furthermore, an electrical energy source 82 is connected by electrical conductors or supply cables to the electromagnets 38. Furthermore, a controller 84 is provided and connected to the energy source 82 for controlling the supply of energy to the electromagnets 38, and preferably individually controlling the supply of energy to individual electromagnets independently of other electromagnets. Thus, while the controller 84 is illustrated connected to the energy source 82 upstream from the energy source 82 relative to the electromagnets 38, alternatively or additionally the controller 84 can be connected to each electromagnet 38. As another alternative, an additional control signal line is connected from the controller to the electromagnets, and the electromagnets can each be individually activated, deactivated or controlled by an addressable control system, wherein each electromagnet reacts to control commands identified by the respective electromagnet's address. For these purposes, the controller 84 can comprise any conventionally known electrical, electromechanical, and/or computer processor based control devices that are suitable for switching on, switching off and variably controlling the respective individual electromagnets. For example, when the runway 78 is not being used, the electromagnets thereof are switched off to conserve energy. On the other hand, when an air vehicle 10 is to perform a take-off or landing on the runway 78 then at least the electromagnets 38 located under the air vehicle 10 are sequentially activated as the air vehicle 10 moves along the runway 78, in order to generate and maintain the necessary levitation effect on the air vehicle 10 as it moves along the runway 78.

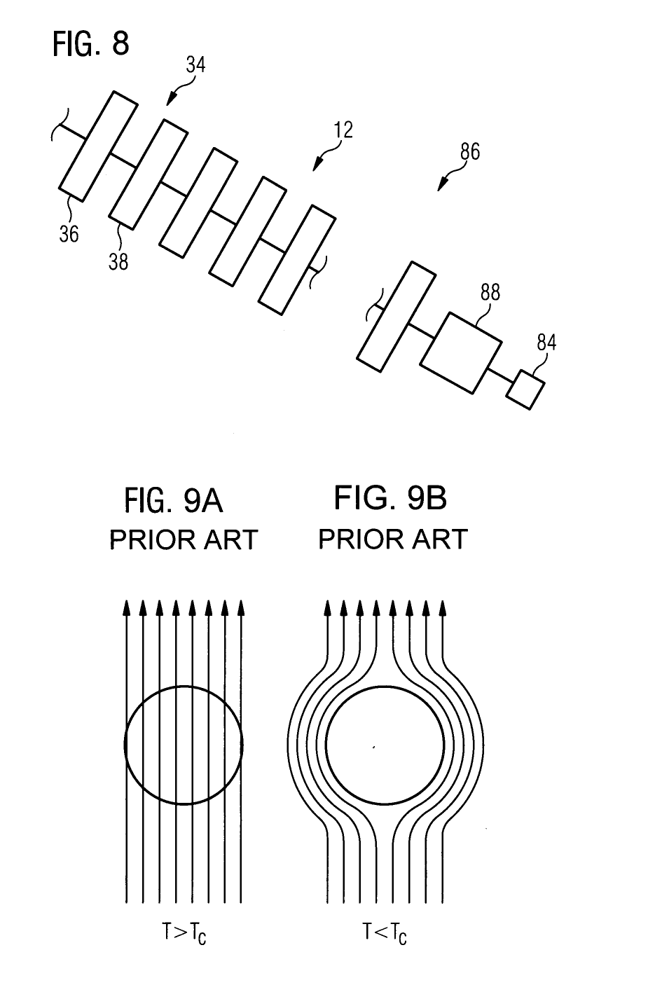

While the example embodiment of the guide path 12 shown in FIG. 7 is stationary and permanently installed under a runway 78, FIG. 8 shows an alternative embodiment of a portable guide path 86 as another example of a guide path 12. In this portable guide path 86, several electromagnets 38 are connected to one another so that they can be rolled up or folded up with one another so that the guide path 86 can be easily transported and deployed to form a temporary guide path 12. For example, in the event of an impending emergency landing of the air vehicle 10, an emergency crew can deliver and unroll, unfold or otherwise deploy the portable temporary guide track 86 on an available field, roadway, or other ground surface area having a sufficient length and width, so that the air vehicle 10 can then land safely on the portable guide track 86 on this field, or roadway or the like. This portable guide path 86 of FIG. 8 also further comprises a portable electrical energy source 82, here in the form of an electrical generator 88, as well as a portable control unit 84 for actuating and controlling the electromagnets 38.

The air vehicle 10 equipped according to an embodiment of the invention may totally avoid and omit a mechanical or physical landing gear. Thereby, the air vehicle 10 also avoids the weight penalty and volume penalty as well as the mechanical, electrical and hydraulic complexity of a conventional landing gear in the air vehicle. By instead equipping the air vehicle 10 with superconducting elements, the mechanical friction and aerodynamic drag penalties of a conventional landing gear are also avoided, and the structure of the air vehicle can be simplified and its aerodynamic configuration improved. Also, the air vehicle 10 can achieve a softer and more efficient take-off due to the improved aerodynamics and avoidance of mechanical friction through contact with the ground. When landing, the air vehicle 10 is “captured” and cushioned on the magnetic field 40, whereby a softer landing can be achieved in comparison to an air vehicle equipped with a conventional mechanical landing gear. Thereby also, the risk of a bad or hard landing can be minimized or avoided. Also, the complexities and difficulties involved with magnetic levitation principles used for maglev trains for example, as discussed above, can also be avoided by the inventive use of the quantum levitation principle. Still further, the operation of the inventive system is independent of weather conditions, so that a take-off or landing procedure of the air vehicle 10 can be performed with improved safety and passenger comfort even in difficult weather conditions (e.g. heavy rain, snow or ice) that would interfere with a landing or take-off using conventional mechanical landing gear. Moreover, the air vehicle 10 can land on all possible ground surfaces, including water, with the only requirement that the guide path 12 can be arranged on the ground surface so as to establish the required magnetic field. These principles of embodiments of the invention apply to all types of air vehicles 10 including manned and unmanned air vehicles, as well as air vehicles that carry out a vertical take-off and landing, as well as air vehicles that take-off and land on terrestrial ground surfaces, water surfaces, surfaces of other planets or moons, surfaces of other vehicles such as an aircraft carrier ship or a space station, etc. Using the inventive system and thereby avoiding mechanical landing gear, fuel can be saved, and a quicker smoother take-off and landing can be achieved.

By avoiding the need for conventional mechanical landing gear, the overall total weight of the air vehicle 10 can be reduced, the structural strength thereof can be reduced, and therefore the air vehicle can also have different design features, for example having different wing designs, smaller propulsion motors, aerodynamically improved fuselage belly contours, and the like. Still further, the noise level in a passenger cabin of a passenger transport air vehicle can be reduced, and the passenger comfort can be improved, because reduced forces and vibrations will be transmitted into the passenger cabin because there is no more mechanical contact of a mechanical landing gear rolling along the ground surface (which may have cracks, bumps, pot holes, or the like). Thereby, not only the take-off and landing phases, but also the taxiing of the air vehicle can be made smoother, quieter, more comfortable for passengers and more economical in terms of fuel consumption and the like. Especially in the last phase of taxiing or rolling to a parking position, the air vehicle 10 can further be engaged and moved by a tug or tractor vehicle, for example, whereby the air vehicle may further be supported on such a vehicle or other mechanical supports during parking. For example, the air vehicle can be supported by the inventive quantum levitation system until reaching its parking position, where the magnetic field is then reduced and switched off, so that the air vehicle settles down onto a parking stand or support structure.

Especially for unmanned air vehicles, the use of superconducting elements instead of a mechanical landing gear in the aircraft can help to make such unmanned aerial vehicles more compact and lighter in weight, and can further facilitate a great flexibility for take-off and landing on essentially any type of ground surface as long as a magnetic field can be produced along a guide path. Use of the inventive system for military aircraft facilitates a quicker and shorter take-off or a quicker and shorter landing, which is especially advantageous in connection with air vehicles deployed from aircraft carrier ships. Furthermore, the use of superconducting elements instead of a mechanical landing gear can also help to extend the maximum mission duration of a military air vehicle, due to the reduction in weight and improvement of aerodynamics.

In embodiments of the inventive system in which the air vehicle includes no mechanical landing gear, therefore, there will also be no mechanical braking and no mechanical steering ability because there is no physical contact between the air vehicle and the ground surface during the take-off, landing and taxiing. Instead, braking and steering control is achieved through the use of the aerodynamic control surfaces of the aircraft, for example the rudder for steering and spoilers for braking, and braking is further provided by thrust reversal or thrust re-direction of the thrust engines of the air vehicle. Furthermore, braking, propulsion and steering guidance while the air vehicle is “captured” or “locked” on the magnetic field of the guide path can additionally be provided by appropriately controlling the field strength and configuration of the magnetic field, and particularly by individually controlling the individual electromagnets along the guide path. The system according to the invention can further include additional magnetic levitation concepts and/or linear electric motor concepts in order to control and propel the air vehicle along the guide path during taxiing, take-off and landing operations. Such magnetically driven propulsion of the air vehicle along the guide track can also be used to supplement the thrust of the main engines of the air vehicle for achieving a quicker shorter take-off.

By appropriately designing and configuring the superconducting elements, a “quantum locking” effect may be achieved, in which the superconducting elements remain levitated and “locked” at a particular spacing distance and orientation relative to the guide path, as established by exerting a sufficient force, e.g. with the aerodynamic control elements of the air vehicle, to place the air vehicle into the desired “captured” or “locked” position relative to the guide path during the landing procedure of the air vehicle. Then, when the forces acting on the air vehicle are m reduced below the force threshold necessary to overcome the quantum locking effect, the established spacing distance and orientation of the air vehicle relative to the guide path will be maintained as long as the magnetic field is maintained by the magnets and the superconducting state is maintained in the superconducting elements.

The term “quantum levitation” generally means or refers to the effect achieved by the interaction of a superconductor with a magnetic field when the superconductor at least partially expels or excludes the magnetic field.

The term “ground surface” generally means or refers to any surface on or over which the air vehicle is to be supported for landing, taking off or taxiing, and is not limited to the terrestrial ground of the earth, but also encompasses surfaces of other planets, and surfaces of manmade structures such as aircraft carrier ships, space stations and the like.

The term “or” is non-exclusive and also covers the meaning of “and/or” unless otherwise specified.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims. The abstract of the disclosure does not define or limit the claimed invention, but rather merely abstracts certain features disclosed in the application.

What is claimed is:

1. An air vehicle comprising a fuselage and at least one magnetically effective element selected from magnets and superconducting elements, wherein said at least one magnetically effective element is arranged in or on a lower portion of said fuselage and is configured and adapted to produce a quantum levitation effect relative to a guide path, sufficient to support said air vehicle above the guide path without physical contact between said air vehicle and the guide path.

2. The air vehicle according to claim 1, wherein said at least one magnetically effective element comprises at least one of said superconducting elements.

3. The air vehicle according to claim 2, further comprising a cooling apparatus operatively connected to said at least one superconducting element so as to cool said superconducting element below a superconducting transition temperature thereof.

4. The air vehicle according to claim 3, further comprising a fuel cell arranged in or on said fuselage, wherein said cooling apparatus contains hydrogen in form of liquified hydrogen or cryo-compressed hydrogen and supplies said hydrogen to said at least one superconducting element for cooling and as a fuel to said fuel cell.

5. The air vehicle according to claim 3, further comprising a superconducting electric drive system arranged in or on said fuselage, wherein said cooling apparatus is further operatively connected to said superconducting electric drive system so as to cool said superconducting electric drive system below a superconducting transition temperature thereof.

6. The air vehicle according to claim 1, wherein said at least one magnetically effective element comprises at least one of said magnets.

7. The air vehicle according to claim 6, wherein said at least one magnet comprises at least one electromagnet, and further comprising an electric energy source arranged in or on said fuselage and electrically connected to said at least one electromagnet.

8. The air vehicle according to claim 7, further comprising a controller connected to said electric energy source or to said at least one electromagnet and configured to control energization of said at least one electromagnet.

9. The air vehicle according to claim 1, wherein said fuselage comprises a fuselage body and wings extending from said fuselage body, and wherein said lower portion having said at least one magnetically effective element is a lower belly surface portion of said fuselage body.

10. The air vehicle according to claim 9, wherein said at least one magnetically effective element covers said lower belly surface portion, which has an area amounting to at least 25% of a plan form area of said fuselage body or has an axial length amounting to at least 50% of an axial length of said fuselage body.

11. The air vehicle according to claim 1, wherein said fuselage comprises a fuselage body and wings extending from said fuselage body, and wherein said lower portion having said at least one magnetically effective element comprises lower wing surface portions of said wings.

12. The air vehicle according to claim 11, wherein said at least one magnetically effective element covers said lower wing surface portions, which each have an area amounting to at least 25% of a plan form area of each of said wings or each have a length amounting to at least 50% of a length of each of said wings.

13. The air vehicle according to claim 1, not including any mechanical landing gear that is connected to said fuselage and that is configured and adapted to make physical contact with the guide path under said air vehicle.

14. The air vehicle according to claim 1, further comprising a mechanical landing gear that is connected to said fuselage and that is configured and adapted to make physical contact with the guide path under said air vehicle.

15. A system comprising, in combination, said air vehicle according to claim 1 and said guide path, wherein said at least one magnetically effective element comprises at least one of said superconducting elements arranged in or on said lower portion of said fuselage of said air vehicle, and wherein said guide path comprises a magnetic field generating arrangement that is configured and arranged to produce a magnetic field which interacts with said at least one superconducting element to produce said quantum levitation effect.

16. The system according to claim 15, wherein said magnetic field generating arrangement comprises a plurality of electromagnets, an electrical energy source connected to said electromagnets so as to supply electrical energy to said electromagnets, and a controller arranged and configured to control the supplying of the electrical energy to said electromagnets.

17. The system according to claim 16, wherein said guide path further comprises a ground surface, and said electromagnets are permanently stationarily embedded in or under said ground surface.

18. The system according to claim 17, wherein said ground surface over and adjacent to said electromagnets is a flat surface without any recessed groove configuration and without any protruding rail configuration.

19. The system according to claim 16, wherein said guide path is portable and configured to be temporarily deployed on top of a ground surface and thereafter removed and re-deployed at another location.

20. A system comprising an air vehicle and a guide path adapted and arranged to guide said air vehicle, wherein, in order to support and space said air vehicle from said guide path, said system further comprises at least one superconducting area arranged in or on said air vehicle, and said guide path comprises a magnetic field generating arrangement adapted and configured to generate a magnetic field that a interacts with said at least one superconducting area.

21. A method of operating the system according to claim 20, comprising:
flying said air vehicle to approach said guide path;
activating superconducting properties of said at least one superconducting area of said air vehicle;
activating said magnetic field generating arrangement to produce said magnetic field that interacts with said at least one superconducting area, at least when said air vehicle has reached a prescribed spacing distance between said air vehicle and said guide path.
